(19) United States
(12) Patent Application Publication
(10) Pub. No.: US 2019/0130357 A1
(43) Pub. Date: May 2, 2019

(54) METHOD AND SYSTEM FOR PROJECT COORDINATION BETWEEN MULTIPLE USERS

(71) Applicant: LOOKIIMEDIA (UK) LIMITED, London (GB)

(72) Inventor: Julia O'TOOLE, London (GB)

(73) Assignee: LOOKIIMEDIA (UK) LIMITED, London (GB)

(21) Appl. No.: 16/093,316

(22) PCT Filed: Apr. 12, 2017
(86) PCT No.: PCT/GB2017/051025

§ 371 Date: Oct. 12, 2018

(30) Foreign Application Priority Data
Apr. 12, 2016 (GB) 1606306.7

(51) Int. Cl. G06Q 10/10; G06Q 10/06

(52) U.S. Cl. CPC G06Q 10/103; G06Q 10/06316; G06Q 10/063114

(57) ABSTRACT

The present invention relates to methods, systems, and programs, for facilitating the creation and coordination of a project. In a first embodiment, the project is received from a project creation interface and a first task is received from a task creation interface. The first task includes first task authorized users permitted to change a first task status. The project and the task are sent to a project facilitation interface. In a second embodiment, for a project including at least a first task and a first user, a first task status is received. The task includes first task authorized users that include the first user exclusive of a second user. The first task status is saved to a project facilitation database.

### FIELD OF INVENTION

The present invention is in the field of project coordination. More particularly, but not exclusively, the present invention relates to project coordination between multiple users.

### BACKGROUND

Increasingly, teams of persons collaborating on a project find themselves working in different locations from one another, sometimes in different countries and time zones. Meetings are often conducted over phone, email, SMS, or video chat.

Coordinating between team members on a complicated project can present a difficult administrative problem, especially when the team members are separately from one another. The difficulty of determining the status of each task or activity of a project can reduce the productivity of a distributed team. For example, the additional administrative burden can make it difficult to re-allocate and re-distribute priorities for subtasks in response to the changing circumstances surrounding a project.

Productivity products, which can be used to help manage and track the progress of the project, however, fail to meet the needs of distributed teams.

Prior products provide unstructured threads where team members can post information in the form of comments and files. A team member seeking information relevant to a particular task may have to review information about other tasks in the unstructured thread product in order to find the desired information, which is inefficient.

Other prior products provide pre-determined folders of general project information that related to schedules, to do lists, documents, alerts, and messages. A team member trying to determine the status of a first task may need to review multiple folders to determine information regarding the status of a particular task. Because each folder may include information relating to other tasks, this may require a user to review irrelevant information to find relevant information as well.

Other prior products provide ways to create lists. While the list model may be useful for a user's solo project, the list model fails to manage or reduce the administrative burden on a team seeking status or information about tasks relevant to individual users.

For at least the reasons provided above, prior products fail to coordinate the organization of a project for multiple users in a distributed environment efficiently. A project coordination tool which overcomes the disadvantages of the prior art, or at least provides a useful alternative is provided below.

### SUMMARY OF INVENTION

According to a first aspect there is provided a method for facilitating the creation of a project. The method comprises:

displaying a project creation interface;

receiving the project from the project creation interface;

sending the project to a project facilitation application;

displaying a task creation interface;

receiving a first task from the task creation interface, the first task including first task authorized users permitted to change a first task status; and

sending the first task to the project facilitation application.

The method may further include the step of:

receiving a second task from the task creation interface, the second task including second task authorized users permitted to change a second task status.

According to a further aspect, the first task authorized users include a first user exclusive of a second user, and the second authorized users include the second user exclusive of the first user.

According to a further aspect, the first task authorized users are permitted to view the first task exclusive of other project users, and the second task users are permitted to view the second task exclusive of the other project users.

According to a further aspect, the first task status includes a first task status colour.

The method may further include the step of:

receiving a project icon from project creation interface, and wherein sending the project to the project facilitation application further includes sending the project icon to the project facilitation application.

The method may further include the step of:

receiving a first task icon from the task creation interface, wherein sending the project and the first task to the project facilitation application further includes sending the first task icon to the project facilitation application.

The method may further include the step of:

receiving a first task field value from the task creation interface, wherein sending the project and the first task to the project facilitation application further includes sending the first task field value to the project facilitation application.

According to a further aspect, the first task includes a first task post.

According to a further aspect, the first task post is a first task attachment.

According to a further aspect, the first task post is a first task short message service (SMS) message.

According to a further aspect, the first task post is a first task voicemail message.

According to a further aspect, the first task voicemail message is dictated into a first task voicemail text.

According to a further aspect, the first task post is a first task comment.

The method may further include the steps of:

displaying a post transfer interface;

receiving a transferred post and a receiving task from the post transfer interface; and

sending the transferred post and the receiving task to the project facilitation server.

The method may further include the step of:

displaying a task transfer interface;

receiving a transferred task and a receiving project from the transfer task interface; and

sending the transferred task and the receiving project to the project facilitation server.

The method may further include the step of:

displaying a post chronology interface, the post chronology interface displaying the first task post of the first task and a second task post of the second task chronologically based on a first post date and a second task date.

According to a further aspect, the first task has a first due date and the second task has a second due date.

The method may further include the step of:

displaying a task chronology interface, the task chronology interface displaying the first task and the second task chronologically based on a first task due date and a second task due date.

The method may further include the step of:

displaying a chat room interface.

The method may further include the step of:

displaying an SMS interface.

The method may further include the step of:

displaying a voice call interface.

The method may further include the step of:

displaying a task notification interface.

According to a further aspect, there is a system configured to facilitate the creation of a project via any method of the first aspect.

According to a further aspect, there is a computer program configured to facilitate a project via any method of the first aspect.

According to a further aspect, there is an electronically readable medium storing a computer program to facilitate a project via any method of the first aspect.

According to a second aspect there is provided a method for facilitating coordination of a project including at least a first task and a first user, the method comprising:

receiving a first task status for the first task from a first client application associated with the first user, the first task including first task authorized users including the first user exclusive of the second user; and

saving the first task status to a project facilitation database.

According to a further aspect, the project further includes a second task and a second user, and the method may further may further include the step of:

receiving a second task status for the second task from a second client application associated with the second user, the second task including second task authorized users including the second user exclusive of the first user; and

saving the second task status to the project facilitation database.

According to a further aspect, the method may further include the steps of the first task status includes a first task status colour.

According to a further aspect, the method may further include the steps of: receiving a first task icon from the first client application; and

saving the first task icon for the project facilitation database.

According to a further aspect, the method may further include the steps of: receiving a first task field value from the first client application; and

saving the first task field value for the first task to the project facilitation database.

According to a further aspect, the method may further include the steps of:

receiving a first task post from the first client application; and

saving the first task post for the first task to the project facilitation database.

According to a further aspect, the first task post is a first task attachment.

According to a further aspect, the first task post is a first task short message service (SMS) message.

According to a further aspect, the first task post is a first task voicemail message.

According to a further aspect, the first task voicemail message is dictated into a first task voicemail text.

According to a further aspect, the first task post is a first task comment.

The method may further include the steps of:

receiving a transferred post and a receiving task from the first client application or the second client application; and

saving the transferred post for the receiving task in the project facilitation database.

The method may further include the steps of:

receiving a transferred task and a receiving project from the first client application or the second client application; and

saving the transferred task for the receiving project in the project facilitation database.

The method may further include the steps of:

receiving a first task due date from the first client application; and

saving the first task due date to the project facilitation database.

According to a further aspect, there is a system to facilitate the coordination of a project via any method of the second aspect.

According to a further aspect, there is a computer program configured to facilitate the coordination of a project via any method of the second aspect.

According to a further aspect, there is an electronically readable medium storing a computer program to facilitate the coordination of a project via any method of the second aspect.

According to a further aspect, there is a method for facilitating the coordination of a project, as described herein with reference to the Figures.

Other aspects are described within the claims.

### BRIEF DESCRIPTION OF THE DRAWINGS

Embodiments will now be described, by way of example only, with reference to the accompanying drawings in which:

FIG. 1: shows a system 100 in accordance with an embodiment;

FIG. 2: shows a system 200 in accordance with an embodiment;

FIG. 3: shows a system 300 in accordance with an embodiment;

FIG. 4: shows a method 400 in accordance with an embodiment;

FIG. 5: shows a system 406 in accordance with an embodiment;

FIG. 6: shows a method 600 in accordance with an embodiment;

FIG. 7: shows a method 700 in accordance with an embodiment;

FIG. 8: shows a method 800 in accordance with an embodiment;

FIG. 9: shows an interface 900 in accordance with an embodiment;

FIG. 10: shows an interface 1000 in accordance with an embodiment;

FIG. 11: shows an interface 1100 in accordance with an embodiment;

FIG. 12: shows an interface 1200 in accordance with an embodiment;

FIG. 13: shows an interface 1300 in accordance with an embodiment;

FIG. 14: shows an interface 1400 in accordance with an embodiment; and

FIG. 15: shows a system 1500 in accordance with an embodiment.

### DETAILED DESCRIPTION OF PREFERRED EMBODIMENTS

The present invention provides a method, system, and computer program to facilitate the coordination of a project.

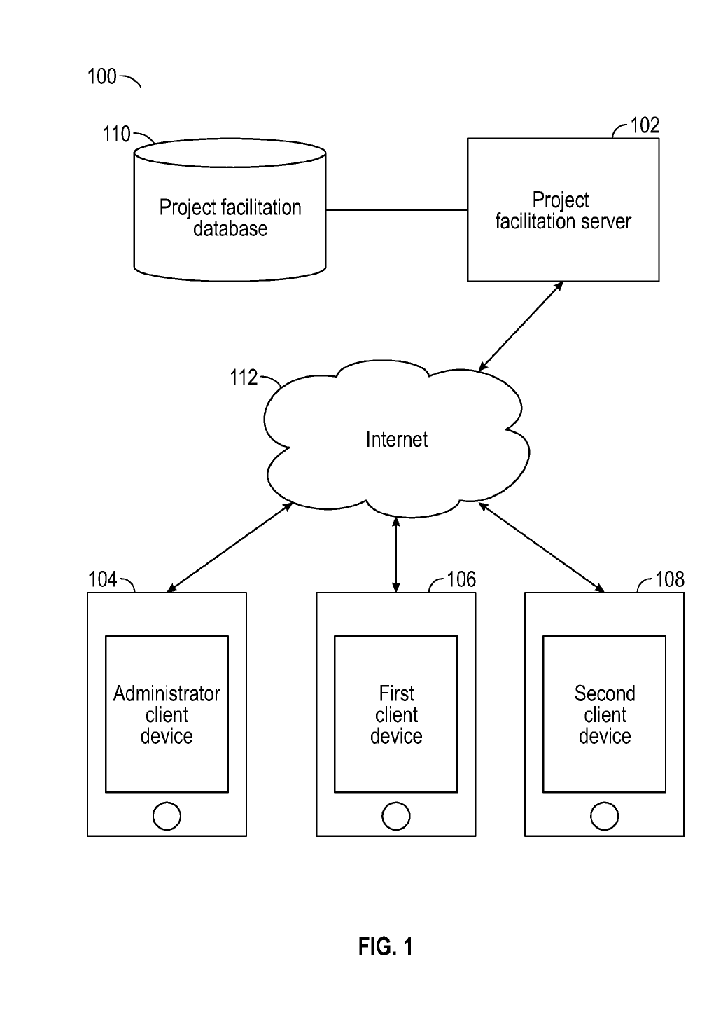

FIG. 1 depicts a system 100 in accordance with an embodiment. System 100 includes project facilitation server 102, administrator client device 104, first client device 106, second client device 108, project facilitation database 110, and Internet 112.

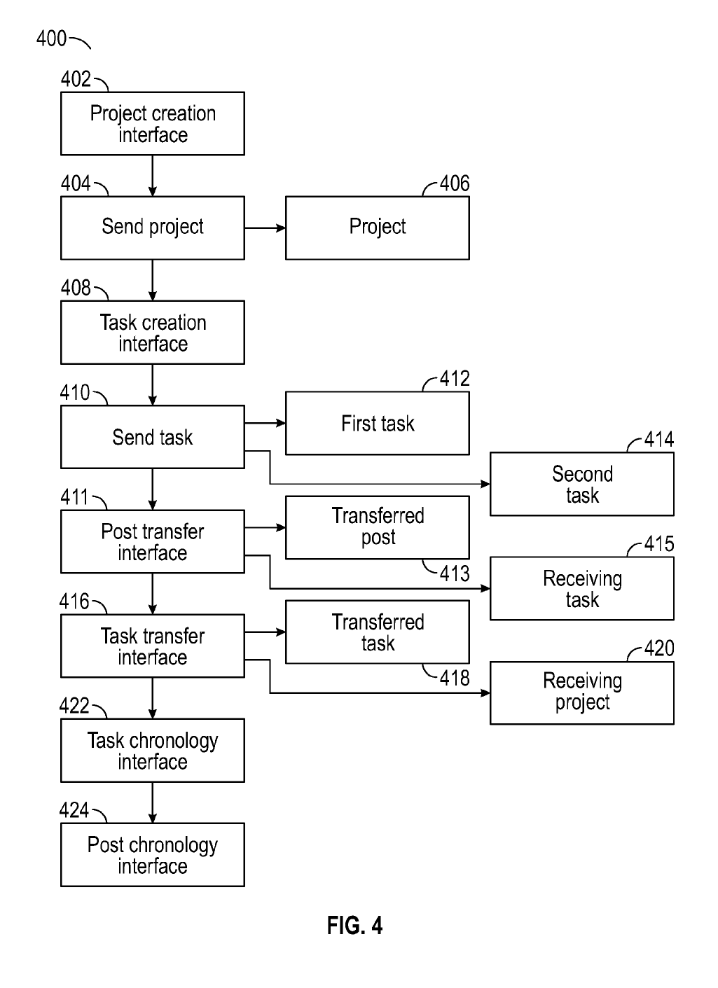

Project facilitation server 102 may be operable to facilitate the creation and management of a project, as described in relation to FIGS. 4 to 12. First and second client devices 104 and 106 may further be operable to create and modify a project, as described in relation to FIGS. 4 to 12.

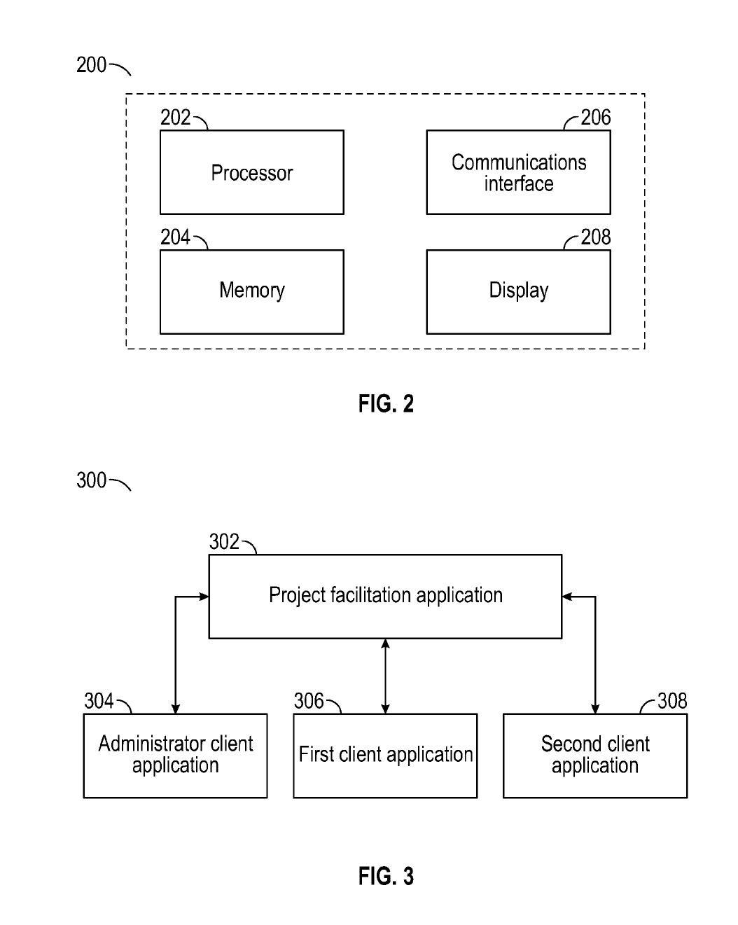

Each of project facilitation server 102, administrator client device 104, first client device 106, second client device 108 may include a processing core 200, as depicted in FIG. 2. Processing core 200 includes a processor 202, a memory 204, and a communication interface 206. In examples, processing core 200 may further include a display 208.

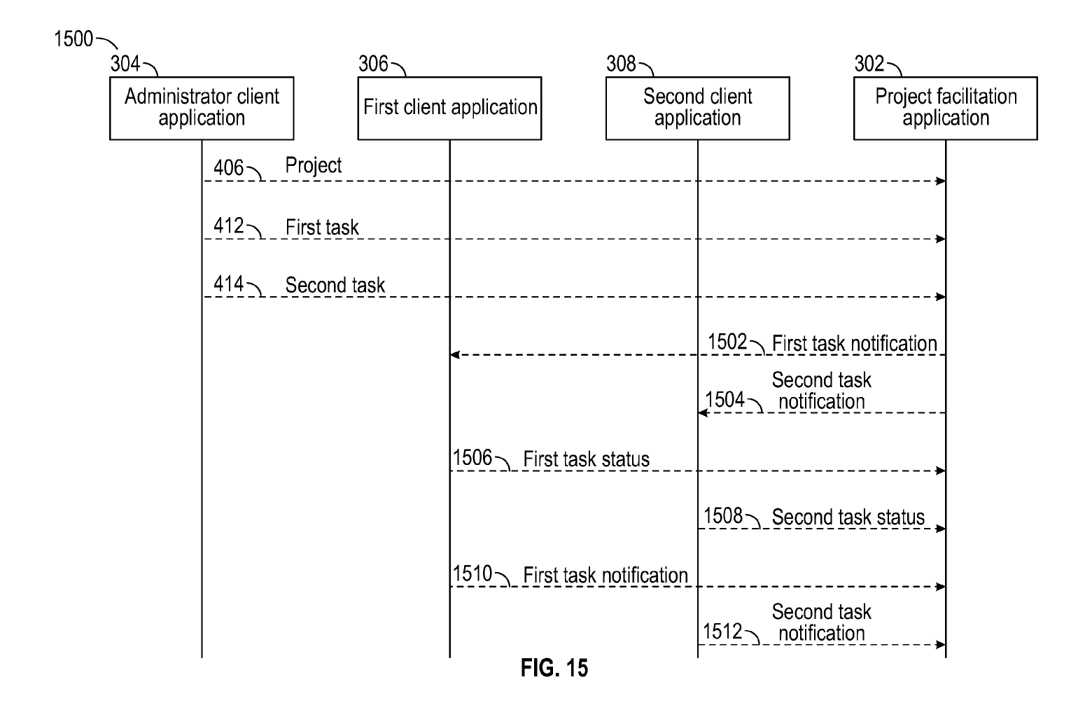

Processor 202 may be configured for executing computer instructions, which, when executed on the system 100, perform a portion or all of the methods described in relation to FIGS. 3 to 15. In embodiments, processor 202 may include a single, or any multiple number of processors, as will be understood by those of skill.

Memory 204 may be an electronically readable medium or a computer readable medium configured to store computer program instructions. In embodiments, memory 204 may include a non-transitory medium.

Stored computer program instructions, when executed on the processor 202, may perform a portion or all of the methods described in relation to FIGS. 4 to 15.

In examples, processor 202 and memory 204 may be incorporated into a custom chipset, such as a system on a chip. For example, processor 202 and memory 204 may be incorporated into a custom Snapdragon, Tegra, Mali-400, Cortex, Samsung Exynos, Intel Atom, Apple, or Motorola chip, or any other type of chip known to those of skill in the art.

In examples, portions of the methods described in relation to FIGS. 4 to 15 may be stored or executed outside of system 100. For example, a portion of the methods described in relation to FIGS. 4 to 15 may be stored or executed on a combination of a server and cloud storage facility via Internet 112.

Communications interface 206 may be configured to communicate with devices external to project facilitation server 102, administrator client device 104, first client device 106, or second client device 108. In examples, communications interface 206 may be wired or wireless interfaces. Communications interface 206 may include a short-range or low-powered wireless standard such as Bluetooth, Bluetooth LE, zigbee, or near field communication (NFC). Communications interface 206 may further include WIFI, 3G, 4G, Ethernet, or any other communications known to those of skill in the art. In examples, processing core 200 may request, send, or receive information, save information, or send or receive messages from a remote device over Internet 112.

When the processing core 200 includes a display 208, the display 208 may be operable to display one or more indicators, or a user interface in conjunction with the methods described in relation to FIGS. 4 to 15.

In examples, any of administrator client device 104, first client device 106, or second client device 108 may be a hand-held or mobile computing device such as a smart phone, a tablet, a smart watch, or a wearable device. In further examples, any of administrator client device 104, first client device 106, or second client device 108 may be a computing apparatus such as a smart TV, a game console, a laptop, or desktop computer, or an app-enabled piece of household hardware.

FIG. 1 further includes a project facilitation server 110. In examples, project facilitation server 110 may be operable to coordinate the facilitation of a project. Project facilitation server 110 may be operable to execute instructions, or to retrieve and save data in a database. In examples, project facilitation server 110 may include a single server, or multiple servers in a distributed architecture. In examples, project facilitation server 110 may support a relational database, a NoSQL database, a distributed database, or any other database known to those of skill.

FIG. 3 depicts system 300, in accordance with an embodiment. System 300 may facilitate the creation and coordination of a project. System 300 includes project facilitation application 302, administrator client application 304, first client application 306, and second client application 308.

Project facilitation application 302 may be configured to allow users to create and manage a project. Administrator client application 304 may be configured to allow a user acting as a project administrator to create, manage, or coordinate a project. First and second client applications 306 and 308 may be configured to allow a user to view, modify, or coordinate a project. In examples, client applications 304, 306, and 308 may be substantially the same client application. Each of client applications 304, 306, and 308 communicate with project facilitation application 302.

In examples, project facilitation application 302, administrator client application 304, first client application 306, and second client application 308 may each operate on separate devices. For example, project facilitation application 302 may operate on project facilitation server 102; administrator client application 304 may operate on administrator client device 104; first client application 306 may operate on first client device 106; and second client application 308 may operate on second client device 108.

In further examples, the functions of any one of project facilitation application 302, administrator client application 304, first client application 306, and second client application 308 may be distributed across additional computing devices. For example, project facilitation application 302 may operate across a group of distributed servers such as project facilitation server 102. FIG. 4 depicts method 400, an example embodiment that may execute within administrator client application 302. Method 400 may allow a user to facilitate the creation of a project 406.

Project 406 is an individual or collaborative enterprise that may be coordinated among users, or team members, to achieve a particular aim or goal. A project may include one or more tasks. A task is an activity to be performed or undertaken, or an idea to be developed. For example, for a project titled, “renovation” directed to renovating a flat, one or more tasks may include, “remove flooring,” “sand trim,” and “paint ceiling.”

Method 400 begins with step 402. In step 402, a project creation interface is displayed. Project creation interface 402 may allow a user to create a new project 406.

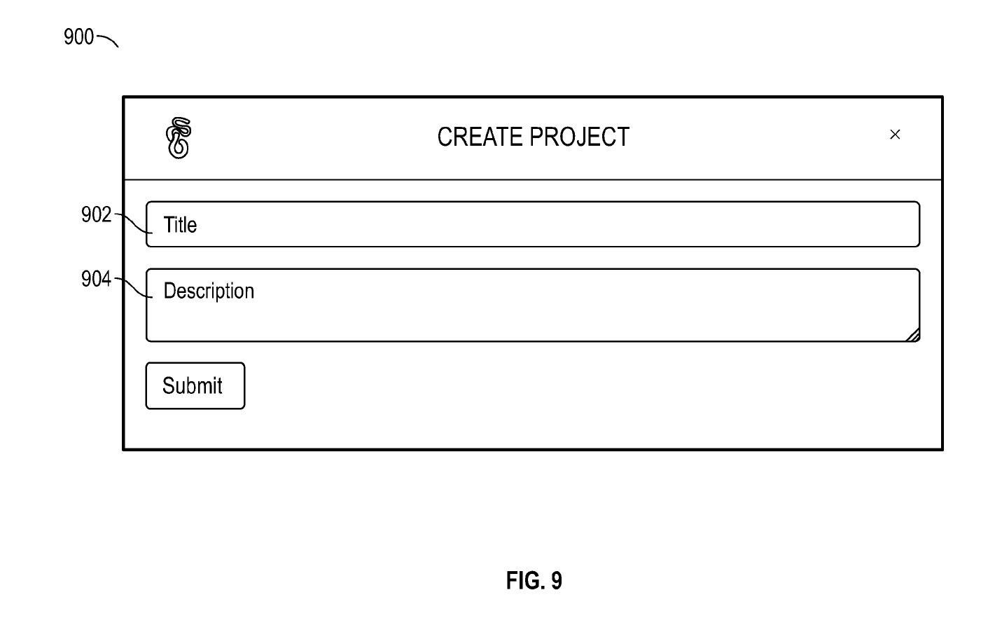

For example, FIG. 9 depicts example project creation interface 900. Project creation interface 900 includes a title parameter 902 and a description parameter 904 that a user may designate when creating project 406. This is not intended to be limiting, however. In examples, project creation interface 402 may include any project parameter for which the user may set a value, including but not limited to: time, location, user rating, and location on a map.

After project 406 is received from the project creation interface 406, method 400 continues with step 404. In step 404, project 406 is sent to project facilitation application 302. In examples, project facilitation application 302 may save project 406 to project facilitation database 110.

In examples, step 402 may include further steps. For example, step 402 may include receiving a project icon from project creation interface. An icon is a picture, piece of film, or display representing a project or a task. Sending the project to the project facilitation application may further include sending the project icon file to the project facilitation application. Alternatively, the project icon may be sent to the project facilitation application in the form of a reference identifier, such as a URL, which may be downloaded by the project facilitation application directly and stored in the project facilitation database 110.

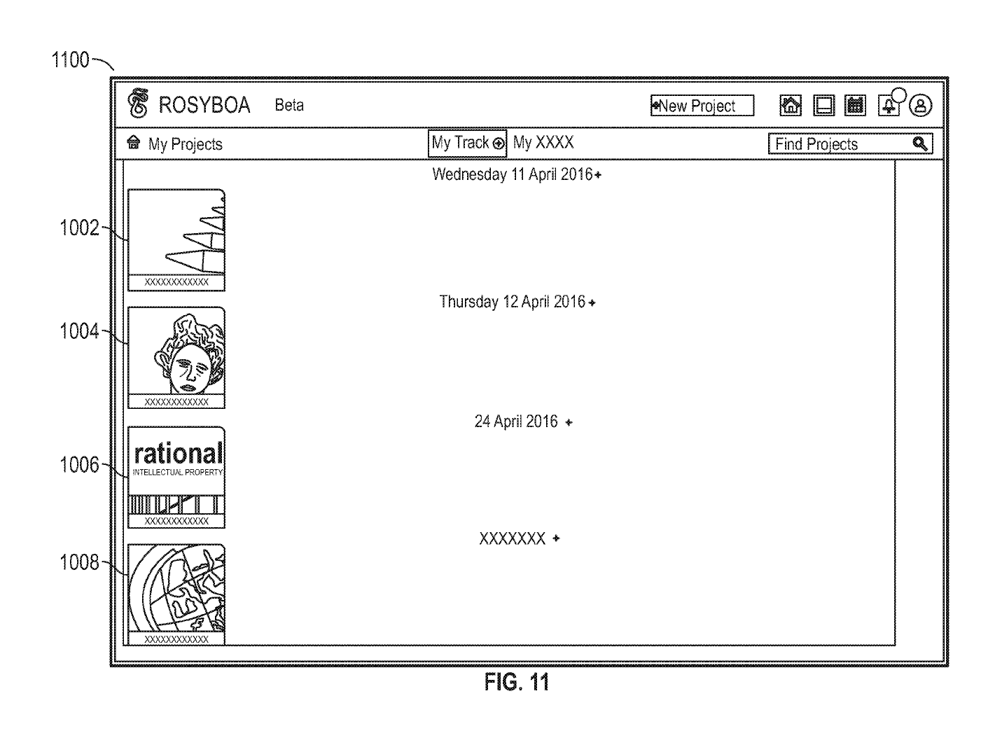

FIG. 11 depicts example project view interface 1100. In example project view interface 1100, an user is included in three projects 1102, 1104, and 1106. Each of projects 1102, 1104, and 1106 are represented by a different project icon.

In examples, project 406 may be sent from administrator client application 304 to project facilitation application 302 via one or more packets of fixed or variable length. For example, project 406 may be represented by a single packet that includes all of the data required to facilitate a project. For example, project 406 may be defined via by the following JSON document:

| | |
|---|---|
| { | ”project_id” : ”a30an39ses”, |
| | ”project_creator” : ”suzie_manager”, |
| | ”project_title” : ”Renovation Project”, |
| | ”project_description” : ”Renovating the kitchen and bathroom” |
| | ″project_authorized_users″: [ |
| | ”username1” : ”paul_painter”, |
| | ”username2” : ”carl_carpetcollector”, |
| | ”username3” : ”sandy_basetrim”, |
| | ”username4” : ”doug_demolition” ] |
| } | |

Method 400 continues with step 408. In step 408, a task creation interface is displayed. The task creation interface 408 allows a user to create a first task related to a project.

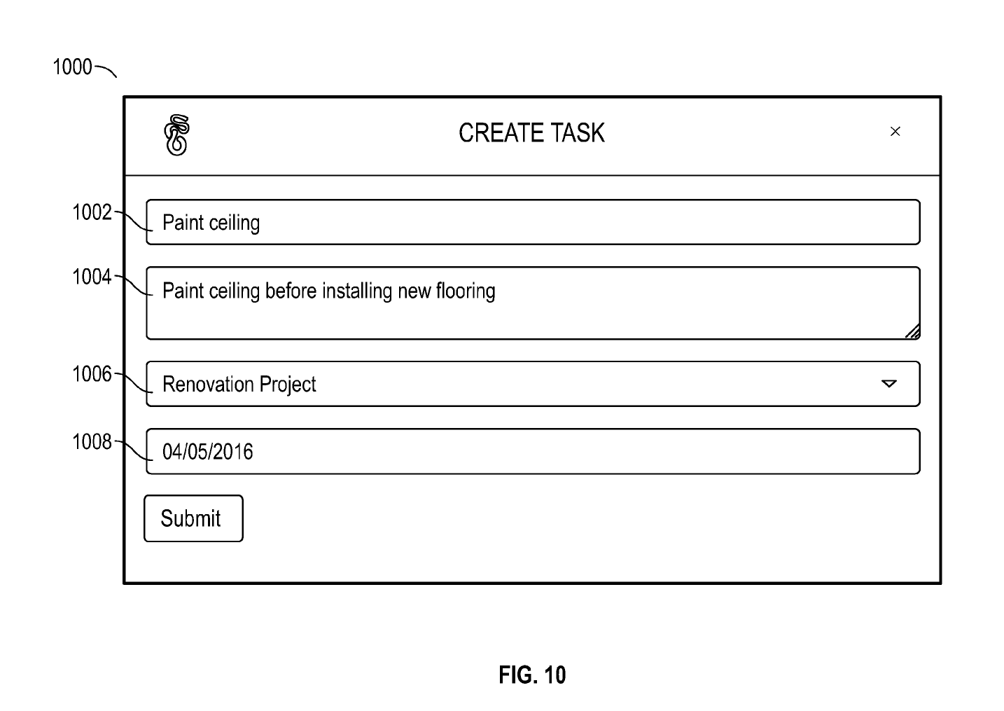

For example, FIG. 10 depicts example task creation interface 1000. Example task creation interface 1000 includes a task title parameter 1002, a description parameter 1004, a project parameter 1006, and a due date parameter 1008. This is not intended to be limiting however, as task creation interface 408 may include fewer or additional parameters.

Method 400 continues with step 410. In step 410, first task 412 is received from the task creation interlace 408, and first task 412 is sent to project facilitation application 302.

First task includes first task authorized users, or those users who are permitted to change a first task status. First task authorized users are permitted to change first task status. In examples, the user creating the task may be automatically included in the first task authorized users.

A task status is a parameter that indicates the progress of a task. In examples, task status may include an enumerated list such as, “to do,” “doing,” and “done.” In examples, task status may have a default value upon task creation, such as “to do.” In further examples, however, a user creating a task may set the status upon task creation with task creation interface 408.

By allowing authorized users to change the task status, users may be able to coordinate working on a project efficiently in a distributed environment.

In examples, a task status may be associated with a task status colour. For example, “to do” may be associated with blue, “doing” may be associated with green, and “done” may be associated with red. This may allow users to determine at a glance the status of one or more tasks in a project.

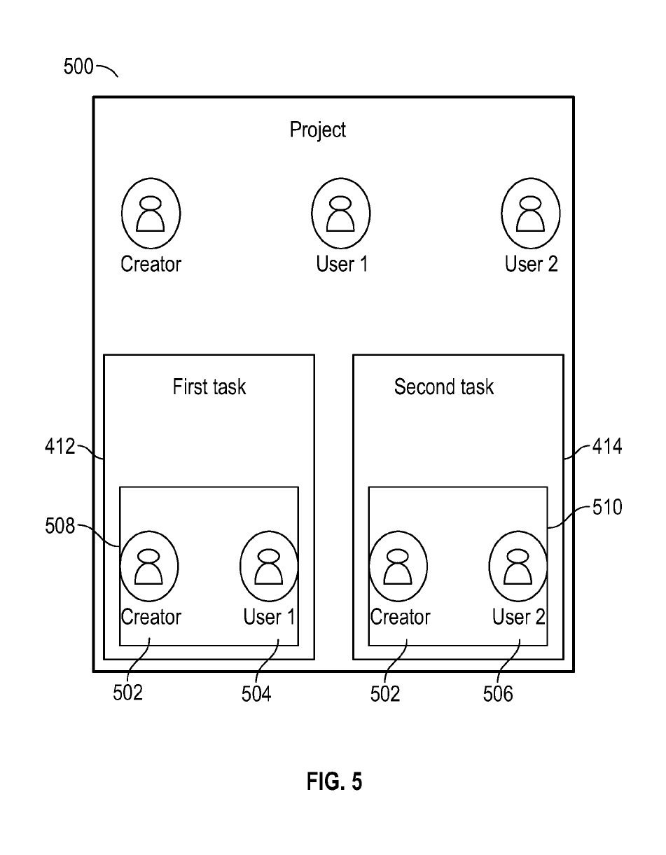

For example, FIG. 5 depicts example project 500. Project 500 includes first task 412. In the example of FIG. 5, first task 412 includes two first task authorized users 508: a project creator user 502 and a first user 504. First task authorized users 508 are permitted to change first task status.

In examples step 408 may further include receiving a first task icon from the task creation interface. Sending the project and the first task to the project facilitation application may further include sending the first task icon to the project facilitation application.

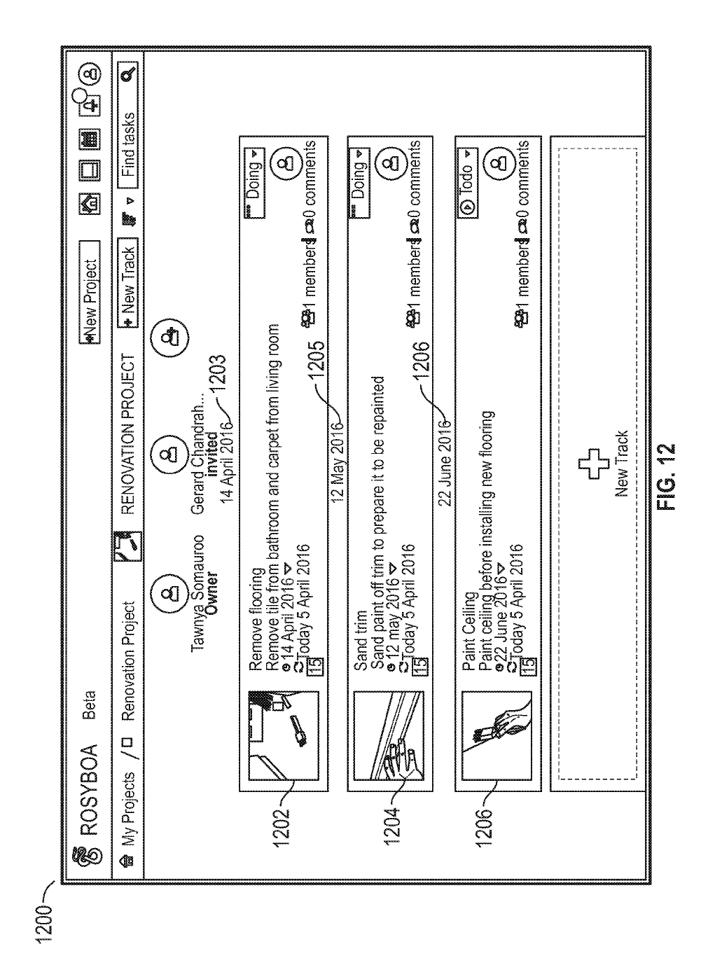

FIG. 12 depicts an example project interface 1200. Project interface 1200 includes three example tasks 1202, 1204, and 1206. As may be seen, each example task 1202, 1204, and 1206 is represented by a different task icon.

In examples, step 408 may include further steps. For example, a first task field value may be received from the task creation interface. First task field value may represent any data field suitable to provide information regarding a task. In examples, first task field value may include, but are not limited by: location, tags, keywords, relationship to other tasks, price, etc. Sending the project and the first task to the project facilitation application in step 410 may further include sending the first task field value to the project facilitation application.

In examples, first task 412 may include a first task post. A post may include information, messages, notes, or documents relating to a task. A task may have any number of posts, therefore serving as a repository of conversations and/or work product around a topic.

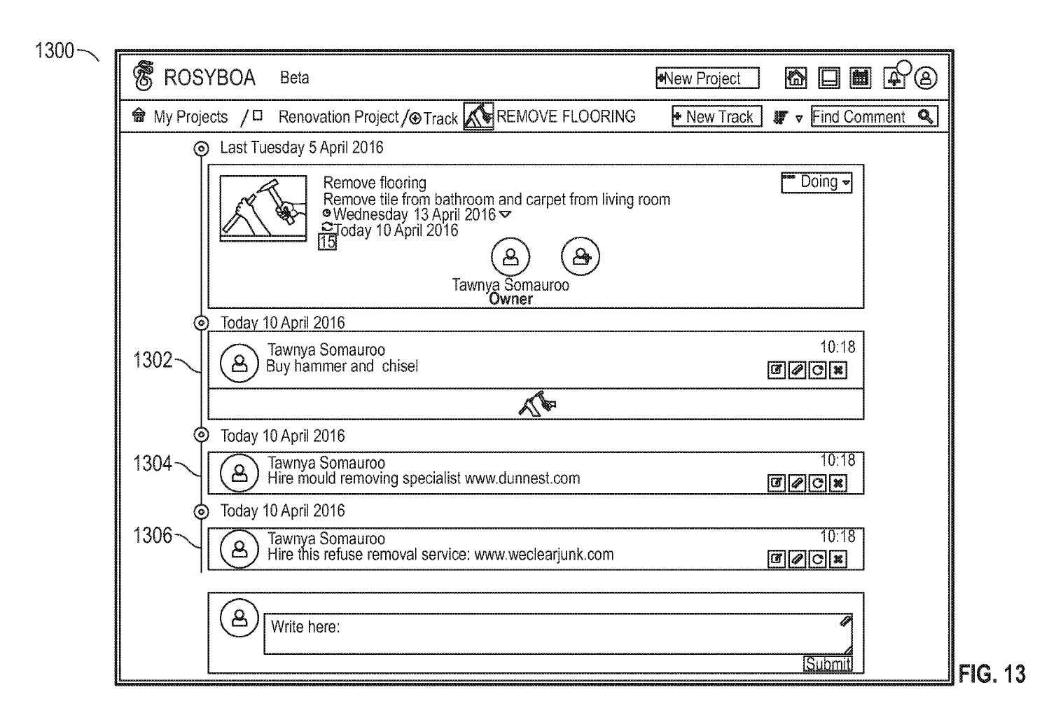

For example, FIG. 13 depicts an example task 1300. Example task 1300, includes a first post 1302, a second post 1304, and a third post 1306.

In examples, first task post may include a first task attachment. First task attachment may be a text, image, video, or any other type of file known to those of skill in the art.

In examples, first task post may include a first task short message service (SMS) message. First task SMS message may include text, images, video, or emoji. Project facilitation application 302 may facilitate sending first task SMS message to other users and receiving SMS messages from other users.

In examples, first task post may include a first task voicemail message. A voicemail message is a recorded verbal message from one user to one or more other users.

In examples, the first task voicemail message may be dictated into a first task voicemail text using any voice to text methods commonly known to those of skill in the art. Sending the project and the first task to the project facilitation application may further include sending the first task voicemail message to the project facilitation application 302.

In examples, first task post may include a first task comment. First task comment may include text, images, video, or emoji.

In examples, step 408 may further include receiving a first due date. A due date is a date when a task should be completed. Sending the project and the first task to the project facilitation application may further include sending the first due date to the project facilitation application 302.

In examples, first task 412 may be represented by one or more packets of fixed or variable length. For example, first task 412 may include a single packet that includes all of the data required to facilitate a task. For example, first task 412 may be defined via by the following JSON document:

| | |
|---|---|
| { | ”task_id” : ”a30an39ses”, |
| | ”task_creator” : ”suzie_manager”, |
| | ”task_title” : ”Renovation Project”, |
| | ”project_id” : ”98rhoow”, |
| | ”task_title” : ”Remove Flooring”, |
| | ″task_authorized_users″: [ |
| | ”username1” : ”carl_carpetcollector”, |
| | ”username2” : ”doug_demolition” ], |
| | ”task_status” : ”To do” |
| | } |

In examples, step 410 may include further steps. For example, step 410 may include receiving a second task 414 from the task creation interface, the second task including second task authorized users permitted to change a second task status.

For example, example project 500 of FIG. 5 includes example second task 414. Example second task 414 includes second task authorized users 510, which include: project creator user 502 and second user 506.

In examples, the first task authorized users may include a first user exclusive of a second user, and the second authorized users may include the second user exclusive of the first user.

For example, project 500 depicted in FIG. 5 provides that first task authorized users 508 include first user 504, but not second user 506. Second task authorized users 510 include second user 506, but not first user 504. In example project 500, first user 504 may change first status of first task 412, and second user 506 may change second status of second task 414.

In examples, first task authorized users 508 may be permitted to view first task 412 exclusive of other project users, and the second task authorized users may be permitted to view the second task exclusive of the other project users.

For example, in the example project 500 of FIG. 5, it may be seen that first user 504 is authorized on first task 412, and second user 506 is authorized on second task 414. This may allow first user 504 and second user 506 to avoid learning information that is not relevant to their respective portions of project 500, lowering the administrative burden of obtaining project status relevant to their roles in the project.

By authorizing individual users only on specific relevant tasks, it is possible to coordinate a project efficiently across a distributed environment.

In examples, method 400 may further include step 411. In step 411, a post transfer interface may be displayed. A transferred post 413 is a post in a prior task that a user has selected to copy or move to receiving task 415. Receiving task 415 may be in the same project, or in a different project that transferred post 413 was previously associated with. In examples where a transferred post 413 is being moved to receiving task 415, transferred post 413 may be deleted from the prior task.

Transferred post 413 and receiving task 415 may be received from the post transfer interface, and sent to the project facilitation server 302.

In examples, method 400 may further include step 416. In step 416 a transfer task interface 416 may be displayed. A transferred task 418 is a task in a prior project that may be copied or moved to a receiving project 420. In examples where transferred task 418 is being moved to receiving project 420, transferred task 418 may be deleted from the prior project.

Transferred task 418 and receiving project 420 may be received from the transfer task interface 416, and sent to the project facilitation server 302.

In examples, method 400 may further include step 422, where a task chronology interface 422 may be provided. A task chronology interface 422 may display first task 412 and second task 414 chronologically based on a first task due date and a second task due date.

For example, FIG. 12 depicts a project including first task 1202, second task 1204, and third task 1206. First task 1202 includes first task due date 1203; second task 1204 includes second task due date 1205, and third task 1206 includes second task due date 1207. As may be seen, first, second, and third tasks 1202, 1204, and 1206 are ordered chronologically from top to bottom, with the task having the earliest due date on top in the example.

Task chronology interface 422 may allow a user to sort and prioritize those tasks that a user is authorized on. In examples, information regarding unauthorized tasks may not be provided to a user, making it easier for the user to identify and coordinate relevant information with other team members.

In examples, method 400 may further include step 424, where a post chronology interface 424 may be provided. A post chronology interface 424 may display first post 1402 and second post 1404 chronologically based on a first post date and a second post date. A post date is the date that a post was made by a user in a task.

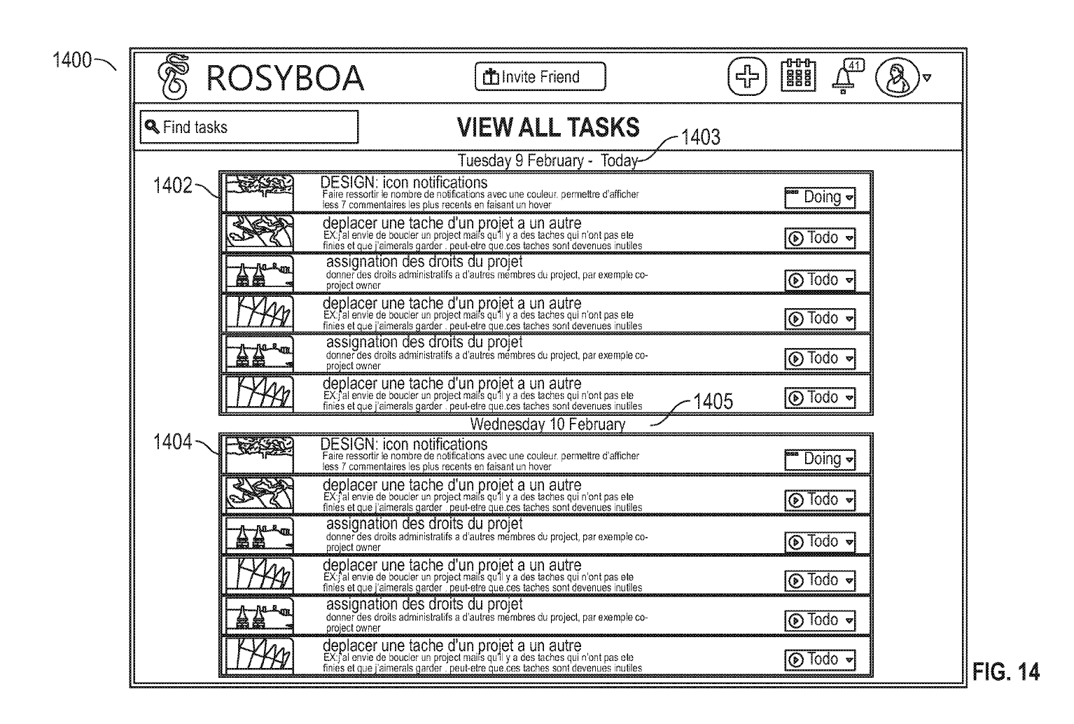

For example, FIG. 14 depicts an example post chronology interface 1400. It may be seen in post chronology interface 1400 that a first post 1402 has a first post date 1403 and a second post 1402 a second post date 1405. First and second posts 1402 and 1404 are ordered chronologically from top to bottom, with first post 1402 having the most recent post date on top in the example.

In examples, first and second posts 1402 and 1404 may be from the same or different tasks. In examples, first and second posts 1402 and 1404 may be from the same or different projects.

Post chronology interface 424 may allow a user to determine quickly what has changed in each task, and when the changes occurred. In a glance, a user may be able to determine the status of one or more tasks and/or projects based on the most recent posts.

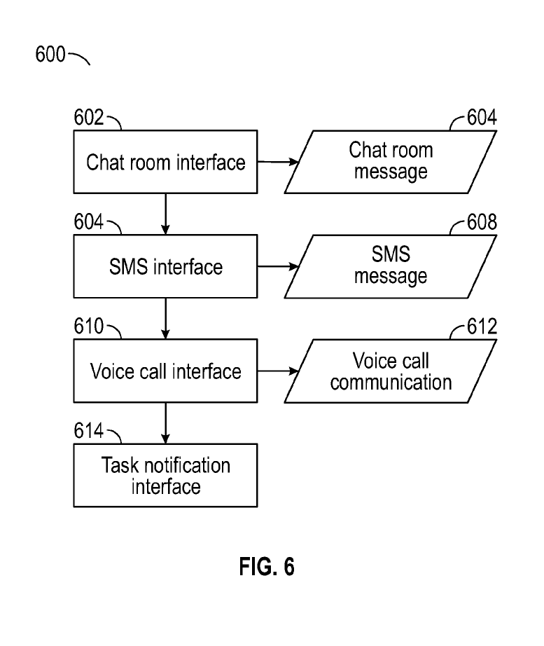

In examples, method 400 may further include any of the steps of Method 600 of FIG. 6. Method 600 includes step 602. In step 602, a chat room interface 602 may be displayed. A chat room interface 602 may be operable to allow one or more users to chat room messages 604, including text, images, video, and/or emoji, to one another in real time.

In examples, method 400 may further include step 606. In step 606 an SMS interface 606 is displayed. SMS interface 606 is operable to allow one or more users to send text, images, video, and/or emoji to one another in real time.

In examples, method 400 may further include step 610, where a voice call interface 610 is displayed. Voice call interface 610 may allow one or ore users to have a phone or video conference.

In examples the one or more users using chat room interface 602, SMS interface 606, or voice call interface 610 may be authorized users of the same task or project.

In examples, method 400 may further include step 614. In step 614, a task notification interface may be displayed. Task notification interface 614 may allow a user to receive alerts regarding new posts created in tasks where a user is authorized.

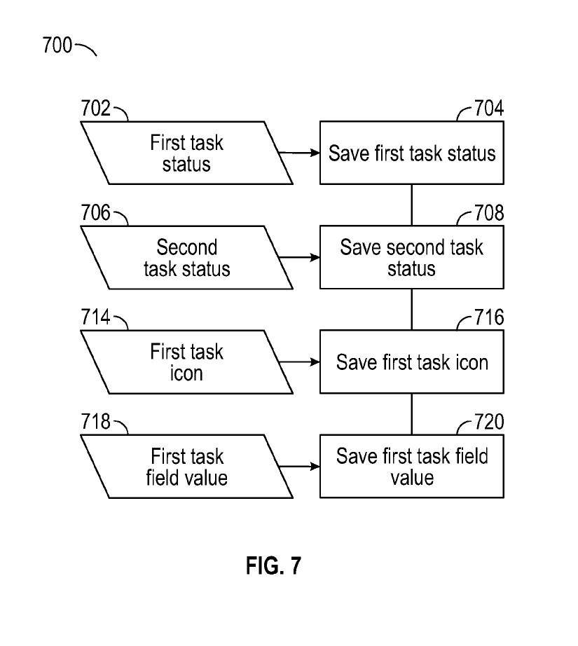

FIG. 7 depicts method 700, an example embodiment that may execute within project facilitation application 302. Method 700 may allow for the facilitation of the coordination of a project including at least a first task and a first user.

Method 700 begins with step 702. In step 702, a first task status is received for the first task from a first client application associated with the first user. The first task includes first task authorized users including the first user exclusive of the second user.

Method 700 continues with step 704. In step 704, the first task status is saved to project facilitation database 110. By saving the status and authorized users for a task, project facilitation server 102 and project facilitation database 110 may help coordinate a project among multiple users in a distributed environment.

In examples, method 700 may include further steps. For example, method 700 may include steps 706 and 708. In step 706, a second task status 706 is received for the second task from a second client application associated with the second user. The second task may include second task authorized users, including the second user exclusive of the first user.

Method 700 continues with step 708. In step 708, the second task status may be saved, for example to the project facilitation database 110.

Method 700 may include steps 710 and 712. In step 710, receiving a first task status colour from the first client application. In step 712, the first task status colour may be saved to the project facilitation database 110.

In examples, method 700 may include steps 714 and 716. In step 714, a first task icon may be received from the first client application. In step 716, the first task icon may be received for the project facilitation database 110.

In examples, method 700 may include steps 718 and 720. In step 718, a first task field value may be received from the first client application. In step 720, the first task field value may be saved for the first task to the project facilitation database 110.

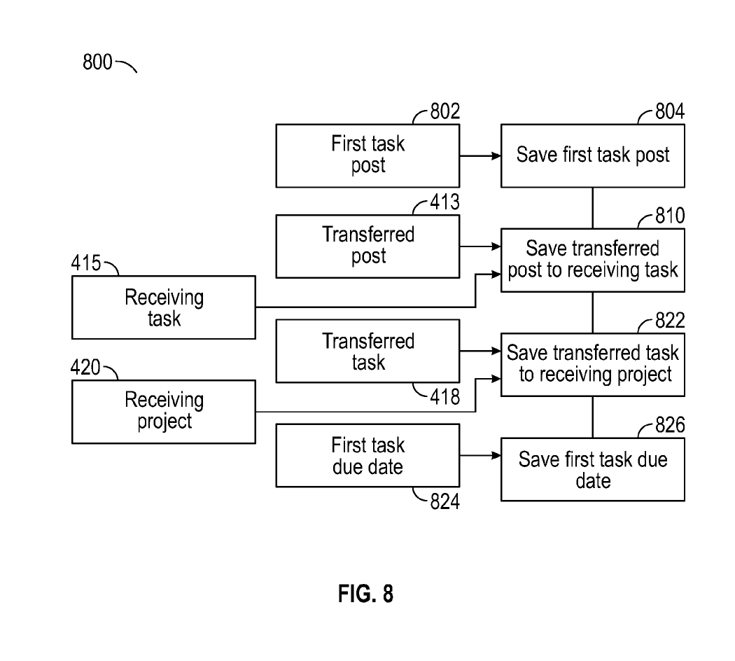

In examples, method 700 may include the steps of method 800 of FIG. 8. Method 800 begins with steps 802 and 804. In step 802, receiving a first task post from the first client application. In step 804, the first task post may be saved to the instance of the first task in the project facilitation database 110.

In examples, method 700 may include further steps. For example, method 700 may include the steps of 413, 415, and 810. In steps 413 and 415, a transferred post 413 and receiving task 415 may be received from first client application or second client application. In step 810, transferred post 413 may be saved for receiving task 415 in the project facilitation database 110.

In examples, method 700 may include further steps. For example, method 700 may include the steps of 418, 420, and 822. In steps 418 and 420, a transferred task and a receiving project may be received from the first client application or the second client application. In step 822, transferred task 418 may be saved with the receiving project 420 in the project facilitation database 110.

In examples, method 700 may include further steps. For example, method 700 may include the steps of 824 and 826. In step 824, a first task due date may be received from the first client application. In step 826, the first task due date may be saved to the project facilitation database 110.

FIG. 13 depicts system 1300, which may be used to create and facilitate the coordination of projects by performing any combination of methods 400, 600, 700, and 800. System 1300 includes administrator client application 304, first client application 306, second client application 308, and project facilitation application 302. In the example system 1300, the administrator client application 304 may be utilized by a user acting as a project administrator or project manager, and first and second client applications 306 and 308 may be utilized by authorized users of the project or the one or more tasks included in the project to facilitate the coordination of the project.

As may be seen from FIG. 13, administrator client application 304 transmits project 406 to project facilitation application 302. Administrator client application 304 subsequently sends first task 412 and second task 414 to project facilitation application 302. For example, administrator client application 304 may generate project 406, first and second task 412, 414 messages using any of the methods described with regards to methods 400, 600, 700, and 800.

In examples, first task 412 or second task 414 may be created by first or second client applications 306 or 308.

Project facilitation application 302 may subsequently notify first and second client applications 306 and 308 that first and second tasks 412 and 414 have been created, for example using first and second task notifications 1502 and 1504.

Once the alert is received at first client application 306, the respective first user may change first task status. In examples, first client application 306 may send first task status 1506 to project facilitation application 302, where it may be saved to project facilitation server 110.

Once the alert is received at second client application 308, the respective second user may change second task status. In examples, second client application 308 may send second task status 1508 to project facilitation application 302, where it also may be saved to project facilitation server 110.

Project facilitation application 302 may subsequently notify first and second client applications 306 and 308 that first and second tasks 412 and 414 have been created, for example using first and second task notifications 1510 and 1512. The first and second users may then receive status regarding their respective tasks, allowing for the efficient coordination of a project in a distributed environment.

In examples, first and second task notifications 1502, 1504, 1510, and 1512 may be defined via by the following JSON document:

| | |
|---|---|
| { | ”task_id” : ”a30an39ses”, |
| | ”task_creator” : ”suzie_manager”, |
| | ”task_title” : ”Renovation Project”, |
| | ”project_id” : ”98rhoow”, |
| | ”task_title” : ”Remove Flooring”, |
| | ″task_authorized_users″: [ |
| | ”username1” : ”carl_carpetcollector” |
| | ”username2” : ”doug_demolition” ], |
| | ”task_status” : ”To do” |
| | } |

In examples, first and second task status 1506 and 1508 may be defined via by the following JSON document:

| | |
|---|---|
| { | ”task_id” : ”a30an39ses”, |
| | ”task_creator” : ”suzie_manager”, |
| | ”task_title” : ”Renovation Project”, |
| | ”project_id” : ”98rhoow”, |
| | ”task_title” : ”Remove Flooring”, |
| | ”task_status” : ”To do” |
| | } |

A potential benefit of some embodiments provided in the present application is that, by providing access control to tasks and tracking whether tasks are completed, multiple users may coordinate their work on a project efficiently in a distributed environment.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art.

Therefore, the invention in its broader aspects is not limited to the specific details, representative apparatus and method, and illustrative examples shown and described. Accordingly, departures may be made from such details without departure from the spirit or scope of applicant's general inventive concept.

1-44. (canceled)

45. A method for facilitating the creation of a project, the method comprising:
displaying a project creation interface;
receiving the project from the project creation interface;
sending the project to a project facilitation application;
displaying a task creation interface;
receiving a first task from the task creation interface, the first task including first task authorized users permitted to change a first task status; and
sending the first task to the project facilitation application.

46. A method as claimed in claim 45, further comprising:
receiving a second task from the task creation interface, the second task including second task authorized users permitted to change a second task status.

47. A method as claimed in claim 46, wherein the first task authorized users include a first user exclusive of a second user, and the second authorized users include the second user exclusive of the first user.

48. A method as claimed in claim 46, wherein the first task authorized users are permitted to view the first task exclusive of other project users, and the second task authorized users are permitted to view the second task exclusive of the other project users.

49. A method as claimed in claim 45, further comprising:
receiving a project icon from project creation interface, and wherein sending the project to the project facilitation application further includes sending the project icon to the project facilitation application.

50. A method as claimed in claim 45, further comprising:
receiving a first task icon from the task creation interface, wherein sending the project and the first task to the project facilitation application further includes sending the first task icon to the project facilitation application.

51. A method as claimed in claim 45, further comprising:
receiving a first task field value from the task creation interface, wherein sending the project and the first task to the project facilitation application further includes sending the first task field value to the project facilitation application.

52. A method as claimed in claim 45, wherein the first task post is a first task comment.

53. A method as claimed in claim 45, further comprising:
displaying a post transfer interface;
receiving a transferred post and a receiving task from the post transfer interface;
sending the transferred post and the receiving task to the project facilitation server;
displaying a transfer task interface;
receiving a transferred task and a receiving project from the transfer task interface; and
sending the transferred task and the receiving project to the project facilitation server.

54. A method as claimed in claim 46, further comprising:
displaying a post chronology interface, the post chronology interface displaying the first task post of the first task and a second task post of the second task chronologically based on a first post date and a second task date; and
displaying a task chronology interface, the task chronology interface displaying the first task and the second task chronologically based on a first task due date and a second task due date.

55. A method for facilitating coordination of a project including at least a first task and a first user, the method comprising:
receiving a first task status for the first task from a first client application associated with the first user, the first task including first task authorized users including the first user exclusive of the second user; and
saving the first task status to a project facilitation database.

56. A method as claimed in claim 55, wherein the project further includes a second task and a second user, and the method further comprises:
receiving a second task status for the second task from a second client application associated with the second user, the second task including second task authorized users including the second user exclusive of the first user; and
saving the second task status to the project facilitation database.

57. A method as claimed in claim 55, further comprising:
receiving a first task icon from the first client application; and
saving the first task icon for the project facilitation database.

58. A method as claimed in claim 55, further comprising:
receiving a first task field value from the first client application; and
saving the first task field value for the first task to the project facilitation database.

59. A method as claimed in claim 55, further comprising:
receiving a first task post from the first client application;
saving the first task post for the first task to the project facilitation database;
receiving a transferred post and a receiving task from the first client application or the second client application; and
saving the transferred post for the receiving task in the project facilitation database.

60. A method as claimed in claim 55, further comprising:
receiving a transferred task and a receiving project from the first client application or the second client application;
saving the transferred task for the receiving project in the project facilitation database;
receiving a first task due date from the first client application; and
saving the first task due date to the project facilitation database.

61. A system configured to facilitate the coordination of a project via a method as claimed in claim 45.

62. A system configured to facilitate the coordination of a project via a method as claimed in claim 55.

63. An electronically readable medium storing a computer program configured to implement the method of claim 45.

64. An electronically readable medium storing a computer program configured to implement the method of claim 55.
